(19) United States
(12) Patent Application Publication
(10) Pub. No.: US 2008/0249872 A1
(43) Pub. Date: Oct. 9, 2008

(54) Systems and Methods for Enabling Users to Sample and Acquire Content

(76) Inventors: Stephen A. RUSSELL, (US); Eric Dahlen, (US); Robert French, (US); Christopher Huber, (US)

Correspondence Address: ROTHWELL, FIGG, ERNST & MANBECK, P.C., 1425 K STREET, N.W., SUITE 800, WASHINGTON, DC, 20005, US

(21) Appl. No.: 12/055,775

(22) Filed: Mar. 26, 2008

Related U.S. Application Data
(60) Provisional application No. 60/908,007, filed on Mar. 26, 2007.

(51) Int. Cl. G06Q 30/00

(52) U.S. Cl. 705/14; 705/1

(57) ABSTRACT

A system for sampling content and presenting targeted marketing and advertising content, comprising: a sample/advertising server; a retail server receiving sample content from the sample server; media sample tablets for receiving sample content and targeted advertising content for display to a user; and means for collecting data from users.

This application claims the benefit of U.S. Provisional Patent Application No. 60/908,007, filed on Mar. 26, 2007 and entitled “Out of Home Entertainment System”. The above identified provisional patent application is incorporated by reference herein in its entirety.

### BACKGROUND

1. Field of the invention

Embodiments of the invention described herein relate to an out of home entertainment system for sampling audio, visual or audio/visual recordings or other content. Embodiments also include a digital filling station system, used in conjunction with the out of home entertainment system, for enabling the sale of digital media directly to portable devices.

2. Discussion of the Background

Technology advancements in the 21st Century have led to substantial changes and problems for companies marketing their products and services. For example, institutional media having access to large blocks of consumers, such as national television networks and periodicals, have given way to media directed to more fragmented markets such as PEOPLE, SIRIUS, YAHOO, HBO, and TIVO. Additionally, traditional venues for delivering ads are a lot less effective than they used to be. In 1965, 20% of primetime adult viewers could correctly recall a commercial in a last break of a television program they had just watched. By 1990, this percentage had dropped to 6%. In 1965, the number of primetime units required to reach 90% of an audience was three. By 2002, this number had increased to 117. Consumers of the present day want to be in control of what they are watching/doing/creating, when they are watching/doing/creating where they are watching/doing/creating.

### SUMMARY

Aspects of the present invention provide systems and methods for facilitating the acquisition of content. Additional aspects provide for facilitating the presentation of targeted marketing and advertising content based on consumer profiles obtained and/or updated during the acquisition of content.

A system according to one embodiment of the invention includes: a content server for providing a master source of digital content; a sample server for providing a master source of digital content samples; a retail server for maintaining a local cache of content and samples of content, and for packaging content; a license server for maintaining licenses, wherein the license server is operable to issue a new license to the retail server at the time of a sale of a piece of digital content and for issuing subsequent licenses for extending usage of said piece of digital content; and a media tablet for providing a consumer interface for exploring the digital content of the system, and for playing content samples, the media tablet comprising: (a) an interface for connection by a portable device for content transfer; (b) means for accepting payment; and (c) means for interacting with the retail server. The system may also include an advertising server for providing dynamic marketing and advertising content.

A method according to one embodiment of the invention includes: providing a media tablet that enables a user to select one or more samples of digital content using the media tablet; receiving an indication that the user has connected a portable device to the media tablet; while the portable device is connected to the media tablet, determining whether the portable device is compatible with at least one of a set of one or more digital rights management (DRM) schemes; and while the portable device is connected to the media tablet, downloading digital content to the portable device using the media tablet, wherein the digital content includes a header that includes license information including the address of a license server.

The above and other aspects and embodiments of the present invention are described below with reference to the accompanying drawings.

### BRIEF DESCRIPTION OF THE DRAWINGS

The accompanying drawings, which are incorporated herein and form part of the specification, illustrate various embodiments of the present invention. In the drawings, like reference numbers indicate identical or functionally similar elements.

FIG. 1. is a functional block diagram of a system according to some embodiments of the invention.

### DETAILED DESCRIPTION OF PREFERRED EMBODIMENTS

As used herein, the words “a” and “an” mean “one or more.”

Embodiments of the out of home entertainment system described herein include system embodiments for providing to consumers samples of music, films, games or other works in locations such as restaurants, malls, supermarkets, bars, airports, waiting rooms, and other similar public places.

The out of home entertainment system embodiments re-engage consumers with particular audio or audiovisual products by allowing consumers to sample the newest music releases or film releases or game releases, or other content, for some embodiments, every week. Users are identified by the out of home entertainment system and user selections are tracked (e.g., sample or other content selections are tracked). User preferences are characterized based upon the tracked selections. The user preferences may be used to trigger relevant ads when the users log into the system, or triggered by analysis of the tracked content selections. Thus, the out of home entertainment system combines attributes of digital signage with the interactivity and measurement effectiveness of internet searching.

Some embodiments of the out of home entertainment system deliver digital rights-managed (DRM) content, for content procurement after sampling, and provide extended licensing so that the portable device content is also retrieved from the device and is usable in other ways, subject to valid license retrieval.

For some embodiments, users spend about fifteen minutes per session of exposure to the samples. Selections made by the users, over time, are used to create a profile of the user. For some embodiments, users provide additional information about themselves, which is also used to create or enhance the profile. This data includes, but is not limited to: age, gender, level of education, address, and income. For some embodiments, the users fill out on-line forms in order to enter the data. For some system embodiments, advertisers are provided with consumer identities and user profiles. The advertisers use the profiles to identify users having interests in particular types of products. Advertisers then use the out of home system to place advertisements directed to users with specific types of interests. Thus, system embodiments described herein exploit the disruption of media and retail in order to provide access to samples to users and to provide user profile information to advertisers.

Out of Home Entertainment System

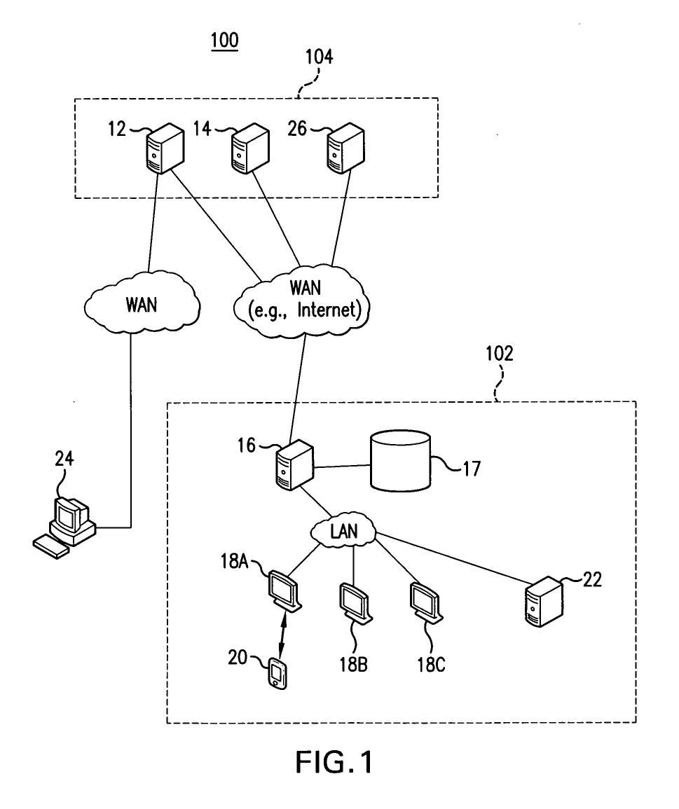

FIG. 1 illustrates an out of home entertainment system 100 according to some embodiments. System 100 may include components for performing functions of sampling, providing content, providing advertisements, packaging content, distributing content, issuing licenses and playing content. As shown in FIG. 1, the example out of home entertainment system 100 includes a license server 12, a content server 14 and a sample/ad server 26 located remotely from a retail site 102 (for example, servers 12, 14 and 26 may be located in a data center 104). As shown in FIG. 1, retail site 102 may include: a retail server 16; a set of media tables 18 (e.g., media tables 18a, 18b and 18c); and a transfer server 22. As further shown, a consumer may bring a portable device 20 into retail site. The consumer may have a PC 24 at home.

The license server 12 may maintain a license for each piece of DRM protected digital content that has been digitally sold through retail site. The license server 12 issues new licenses to retail server 16 for each piece of content at the time of sale, and the server 12 also issues subsequent licenses to the users for automatically extending their usage of the purchased content based on the license that has already been purchased in the store. The license server 12 acts as a central repository of all licensing data and rights rules. License requests are made to the repository.

Content server 14 may provide a master source of digital content to the entire system. As such, the content server 14 represents the 30 content provider in the digital rights management model. The content server 14 is also responsible for the protection of the content, with respect to digital rights, but independently of any published DRM mechanism.

The Retailer Server 16 may maintain a local cache 17 of the most popular content, package the content for delivery to the digital device, including the application of the appropriate digital rights management overhead, and interact with the license server 12 to generate/record licenses. For some embodiments, the retail server 16 encrypts the content and packages it with its licensing information.

The media tablets 18A, 18B and 18C provide a customer interface for exploring an available catalog of digital content, previewing the content as applicable and selecting items for purchase. The media tablets 18A-18C may include an interface (physical or wireless) to which a portable device 20 may connect for the transfer of content. The media tablets 18A, 18B and 18C may accept payment for the content (e.g., they may include a credit/debit card reader), and the media tablets 18A-18C interact with the retail server 16 to request a rights-managed content package which it then downloads to an attached portable device 20. For some embodiments, the media tablets 18A, 18B and 18C deliver the licensed content to the consumer or device.

The transfer server 22 (a.k.a., “data filling station 22”) may provide an alternate means of providing content to a consumer's portable device 20. For example, instead of a consumer connecting his/her portable device 20 to a media tablet 18, the consumer may connect the portable device 20 to the transfer server 22 for the downloading of content which the consumer may have purchased using a media tablet 18.

The portable device 20, as alluded to above, is the recipient of purchased digital content. The portable device 20 is, for some embodiments, a rights management capable device, with a rights management scheme that is supported by the system. Portable devices 20 typically includes a device or software application that renders the digital media for its intended use (audio player, video player, e-book viewer, and other similar devices).

For many embodiments, the consumer has access to PC 24 and a mechanism of connecting the portable device 20 to the PC 24. The PC 24 may be configured to retrieve or receive from the portable device 20 digital content stored in device 20 that was acquired in retail site 102 and store the digital content on, for example, the PC's hard drive. The PC 24 may also be configured to interact with the license server 12 in order to acquire any additional licensed usage capabilities including the automatic acquisition of any licensing that was already purchased at retail.

The sample/ad server 26 maintains a cache of the samples for access by users. The sample/ad server 26 provides sample content to the media tablet 18A, 18B or 18C. The sample/ad server 26 receives, and stores samples. For some embodiments, server 26 also enables users to enter information about themselves. For some embodiments, server 26 selects samples for a particular user based upon past selections and information provided by the user.

### EXAMPLES

Media Sampling

Using a media tablet 18, for some embodiments, consumers enter data about themselves, such as age, sex, city of residence, education, annual income, and audio or audiovisual preferences. For some embodiments, a server (e.g., server 26) maintains a record of the content samples that the Consumer has sampled in the past and provides sample choices to the Consumer based upon past selections. For some embodiments, Consumers select samples from a menu. The menu may be displayed on the media tablet's display screen or on a portable device held by the Consumer. For some embodiments, the portable device is a cellular phone. For some embodiments, Consumers select samples by performing a search based upon title of a work, or composer or artist or other criteria. For some embodiments, the Consumer uses a media tablet 18 to select and 15 peruse samples.

Purchase at Retail Using Media Tablet:

The following will describe a process according to an embodiment of the invention.

The process may begin with a Consumer selecting a content using the media tablet 18. Using the media tablet, the Consumer selects content to be purchased. The media tablet prompts the Consumer to connect a portable device.

The media tablet then may determine whether the portable device is compatible with one or more of a set of supported rights-management schemes and that the device has enough remaining storage space for the selected content. For example, the media tablet may receive from the portable device, automatically after the portable device is attached to the media tablet or in response to a request from the media table, information that can be used by the media tablet to determine the right-management schemes, if any, supported by the device and the amount of free storage space the device has.

If the media tablet determines that the portable device is compatible and has enough space, the media tablet may prompt the Consumer to swipe a credit/debit card and then completes a payment transaction. Assuming the payment transaction was successful, the media tablet requests the selected content from the retail server 16.

The retail server, in response, may send a request to the content server 14 for the selected content. The content server may validate the request. Retail server must present an authentic request and its identity must be known and enabled in the system database. If the retail server is authenticated, the retail server may download the selected content from content server 14.

After obtaining the selected content, retail server 16 generates a license for each piece of selected content and sends these new licenses to license server 12 (preferably using an encrypted channel—e.g., SSL using 128-bit encryption). The retail server encrypts the content with the license information, which includes the usage rules and the network address of the license server by which further licenses can be retrieved. Next, the retail server notifies the media tablet of the availability of the content. The media tablet then downloads the rights-managed content from the retail server and writes the rights-managed content to the attached portable device.

After obtaining the selected content using his/her portable device, the consumer may attach the portable device to PC 24 and copy onto PC 24 the selected content (or at least one or more pieces of the selected content). When the consumer uses media player software running on PC 24 to open a piece of content (e.g., a song) copied on to PC 24, the player software may extract from the license information included with the content at the time of purchase (e.g., stored on a header) the network address of a license server and transmit a request to the license server for a license. The request may include information obtained from the license information. The license information included in the request allows the license server to identify the purchase and automatically extend the license based on the consumers retail purchase so that the user can user the player software on PC 24 to play the content purchased in retail site 102.

In response to the request, the license server 12 validates the request and replies to the software with a new license or a message indicating a denial. If license is issued, the player software adds the license to its license storage and opens the content as requested by the user.

In this description, numerous specific details are set forth. However, it is understood that embodiments of the invention may be practiced without these specific details. In other instances, well-known circuits, structures and techniques have not been shown in detail in order not to obscure the understanding of this description. Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein. Each claim, as may be amended, constitutes an embodiment of the invention, incorporated by reference into the detailed description.

What is claimed is:

1. A system for sampling digital media, comprising:
a content server for providing a master source of digital content;
a sample/ad server for providing a master source of digital content samples and for providing targeted marketing and advertising content which is contextual to the profile of the user;
a retail server for maintaining a local cache of content and samples of content, and for packaging content;
a license server for maintaining licenses, wherein the license server is operable to issue a new license to the retail server at the time of a sale of a piece of digital content and for issuing subsequent licenses for extending usage of said piece of digital content; and
a media tablet for providing a consumer interface for exploring the digital content of the system, and for playing content samples, the media tablet comprising: (a) an interface for connection by a portable device for content transfer; (b) means for accepting payment; and (c) means for interacting with the retail server.

2. A method for sampling and selling digital content, comprising:
providing a media tablet that enables a user to select one or more samples of digital content using the media tablet;
receiving an indication that the user has connected a portable device to the media tablet;
while the portable device is connected to the media tablet, determining whether the portable device is compatible with at least one of a set of one or more digital rights management (DRM) schemes; and
while the portable device is connected to the media tablet, downloading digital content to the portable device using the media tablet, wherein the digital content includes a header that includes license information including the address of a license server.
